(19) United States
(12) Patent Application Publication
(10) Pub. No.: US 2007/0095028 A1
(43) Pub. Date: May 3, 2007

(54) Upright vacuum cleaner

(75) Inventors: Jae Kyum Kim, Gimhae-si (KR); Young Gun Min, Changwon-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 11/260,684

(22) Filed: Oct. 28, 2005

(51) Int. Cl. B01D 50/00

(52) U.S. Cl. 55/337

(57) ABSTRACT

A vacuum cleaner includes a cleaner body, a dust collector coupled to the cleaner body, a dust collecting container and a filter assembly. The dust collector includes a cyclonic chamber including a primary cyclone in fluid communication with the cleaner body and having a primary airflow inlet located on an upper portion of the primary cyclone at one side of the primary cyclone and a primary airflow outlet located on an upper portion of the primary cyclone at the center of the primary cyclone, and at least one secondary cyclone disposed around the primary cyclone for separating contaminants entrained in the airflow discharged from the primary cyclone.

### BACKGROUND

This description relates to upright vacuum cleaners used for suctioning dirt and dust from carpets and floors.

Upright vacuum cleaners include a cleaner body having a handle, by which an operator of the vacuum cleaner may grasp and maneuver the cleaner, and a nozzle section which travels across a floor, carpet, or other surfaces being cleaned.

The cleaner body is often formed as a rigid plastic housing which encloses a dirt and dust collecting filter bag. The nozzle section is connected through a hinge to the cleaner body such that the cleaner body is pivotable between a generally vertical upright storage position and an inclined operative position. The underside of the nozzle section includes a suction opening formed therein which is in fluid communication with the filter bag.

A suction source, such as a motor and fan assembly, is enclosed either within the nozzle section or the cleaner body of the cleaner. The suction source generates the suction force required to pull dirt from the carpet or floor through the suction opening and into the filter bag.

Another type of upright vacuum cleaner utilizes cyclonic airflow to avoid the need for vacuum filter bags, and the associated expense and inconveniences of replacing filter bags. The cyclonic airflow is used instead of the filter bag to separate a majority of the dirt and other particulates from the suction airflow. The air is then filtered to remove residual particulates, returned to the motor, and exhausted.

However, conventional cyclonic airflow upright vacuum cleaners have not been found to be entirely effective and convenient to use. For example, with conventional cyclonic airflow vacuum cleaners, the process of emptying dust and dirt from dust collector may be inconvenient. Also, in a conventional vacuum cleaner having the above-mentioned configuration, the coupling structure of the dust collector may be complex and therefore difficult to use.

Also, in the conventional vacuum cleaner having the above-mentioned configuration, the suction source may become overheated when a clog occurs in the vacuum cleaner.

### SUMMARY

In one general aspect, a vacuum cleaner includes a cleaner body, a dust collector coupled to the cleaner body, a suction source located in the cleaner body and having a suction source inlet in fluid communication with the dust collector and a suction source outlet, and a main filter assembly located on the dust collector for filtering contaminants from the airflow.

The dust collector includes a cyclonic chamber providing a cyclonic airflow for separating contaminants entrained in the airflow and a dust collecting container for storing the contaminants.

The cyclonic chamber includes a primary cyclone and at least one secondary cyclone. The primary cyclone may be provided in fluid communication with the cleaner body and/or may include a primary airflow inlet located on an upper portion of the primary cyclone at one side of the primary cyclone and a primary airflow outlet located on an upper portion of the primary cyclone at the center of the primary cyclone. The at least one secondary cyclone may be installed around the primary cyclone for separating contaminants entrained in the airflow discharged from the primary cyclone.

The dust collecting container may include a primary dust storing part for storing contaminants separated in the primary cyclone and secondary dust storing part for storing contaminants separated in the secondary cyclone.

The primary cyclone may have a cylindrical shape and the primary airflow inlet of the primary cyclone may be tangentially oriented in relation to an axial centerline of the primary cyclone. The secondary cyclones may have a partial conical shape and be partitioned with respect to each other by peripheral walls of the secondary cyclone.

The vacuum cleaner may include a coupling device for coupling the dust collector to the cleaner body.

The coupling device may have a coupling protrusion formed at the front of the cleaner body and/or a latch provided at the upper end of the dust collector.

The latch may have a fastening bar which moves upwardly for coupling the dust collector to the cleaner body and moves downward for detaching the dust collector from the cleaner body.

The fastening bar may include a hook corresponding to a mating groove formed in the coupling protrusion.

The main filter assembly may include a main filter element that includes an expanded polytetrafluoroethylene (PTFE) membrane.

The vacuum cleaner may also include a final filter assembly connected in fluid communication with the suction source outlet and adapted for filtering the airflow exhausted by the suction source prior to the airflow being dispersed into the atmosphere. The final filter assembly may include a high efficiency particulate arrest (HEPA) filter medium.

Upon activation of the suction source, contaminants from a surface being cleaned may be entrained in the airflow. The airflow travels (a) from the cleaner body into the primary cyclone through the primary airflow inlet, (b) downwardly from the primary airflow inlet and in a spiral within the primary cyclone so that the entrained contaminants are separated from the suction airflow, (c) upwardly from the primary cyclone into the secondary cyclone through a secondary airflow inlet of the secondary cyclone, (d) downwardly from the secondary airflow inlet and in a spiral within the secondary cyclone so that contaminants are separated from the airflow flowing into the secondary cyclone, and (e) upwardly from the secondary cyclone into the suction source passing through the main filter assembly and outwardly through an exhaust of the vacuum cleaner.

In accordance with another general aspect, a vacuum cleaner includes a nozzle section defining a suction opening, a cleaner body pivotally mounted to the nozzle section and in fluid communication with the nozzle section, a primary cyclone for separating contaminants from an airflow, the primary cyclone being in fluid communication with the suction opening, and at least one secondary cyclone for separating contaminants entrained in the airflow discharged from the primary cyclone.

A suction source may include a suction source inlet in fluid communication with the secondary cyclone and a suction source outlet in fluid communication with the atmosphere.

A thermal protection device may be provided for preventing a motor of the suction source from overheating.

A conduit may operatively connect the suction opening in fluid communication with a primary airflow inlet of the primary cyclone.

A fitting member may support and connect the conduit to a passage which is in fluid communication with the suction opening.

A main filter assembly may include a main filter element, wherein the main filter element is located on an upper portion of the secondary cyclone.

The main filter element may be supported by a filter support member. The primary airflow inlet may be tangentially oriented and arranged so that the airflow entering the primary cyclone through the primary airflow inlet moves spirally within the primary cyclone.

In another general aspect, an upright vacuum cleaner may include a nozzle section defining a suction opening; a cleaner body coupled with the nozzle section about a hinge; a primary cyclone for separating contaminants from an airflow, the primary cyclone being in fluid communication with the suction opening; and at least one secondary cyclone for separating contaminants entrained in the airflow discharged from the primary cyclone.

A suction source may include a suction source inlet in fluid communication with the secondary cyclone and a suction source outlet in fluid communication with the atmosphere.

A main filter assembly may include a main filter element, the main filter element being located on an upper portion of the at least one secondary cyclone.

The at least one secondary cyclone may be disposed in a position around a periphery of the primary cyclone.

The vacuum cleaner may include a plurality of secondary cyclones.

The secondary cyclones may be partitioned from an adjacent secondary cyclone, such as by the peripheral walls of the secondary cyclones.

A primary airflow inlet of the primary cyclone may be tangentially oriented and arranged so that the airflow entering the primary cyclone through the primary airflow inlet moves spirally within the primary cyclone.

A conduit may operatively connect the suction opening in fluid communication with a primary airflow inlet of the primary cyclone.

In another general aspect, a method provides a way of cleaning a surface with an upright vacuum cleaner having a suction source, a cleaner body, a dust collector coupled to the cleaner body, a dust collecting container and a filter assembly, the dust collector including a cyclonic chamber having a primary cyclone in fluid communication with the cleaner body and at least one secondary cyclone disposed around a periphery of the primary cyclone.

The method may include activating the suction source to produce an airflow pathway for entraining contaminants from the surface into the airflow pathway.

The method may include exhausting air from the upright vacuum cleaner.

The airflow pathway may extend from the cleaner body of the vacuum cleaner into the primary cyclone.

The airflow pathway may extend in a spiral within the primary cyclone so that the entrained contaminants are separated from the suction airflow.

The airflow pathway may extend upwardly from the primary cyclone into the at least one secondary cyclone.

The airflow pathway may extend in a spiral within the at least one secondary cyclone so that contaminants are separated from the airflow flowing into the secondary cyclone.

The airflow pathway may extend upwardly from the secondary cyclone and passing through the main filter assembly.

Such a vacuum cleaner may provide a simple coupling structure, is convenient to use, and may prevent a suction source from overheating during operation, such as when a clog occurs in the vacuum cleaner.

Other features and advantages will be apparent from the following description, including the drawings, and the claims.

### BRIEF DESCRIPTION OF THE DRAWINGS

FIG. 1 is a perspective view of a cyclonic airflow upright vacuum cleaner.

FIG. 2 is a side view of the vacuum cleaner of FIG. 1.

FIG. 3 is a rear view of the vacuum cleaner of FIG. 1.

FIG. 4 is a bottom, plan view of the vacuum cleaner of FIG. 1.

FIG. 5 is a partial, side sectional view of the vacuum cleaner of FIG. 1.

FIG. 6 is an exploded, perspective view of the dust collector shown in FIG. 1.

FIG. 7 is a perspective view of an upper part of the dust collector of FIG. 6.

FIG. 8 is a partial, side sectional view of the dust collector of FIG. 6.

### DETAILED DESCRIPTION

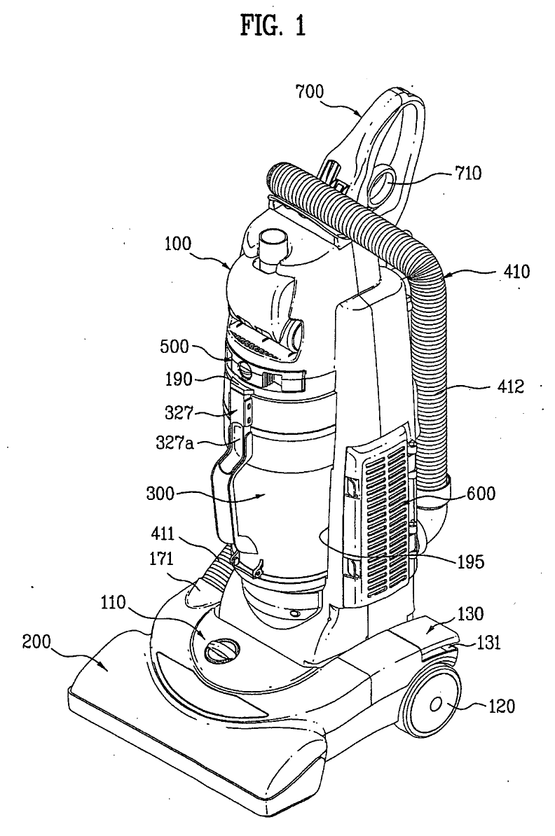

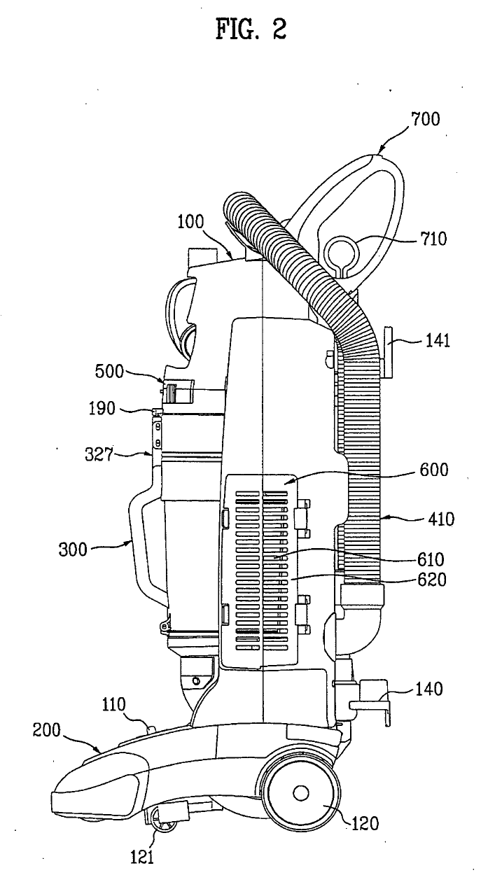

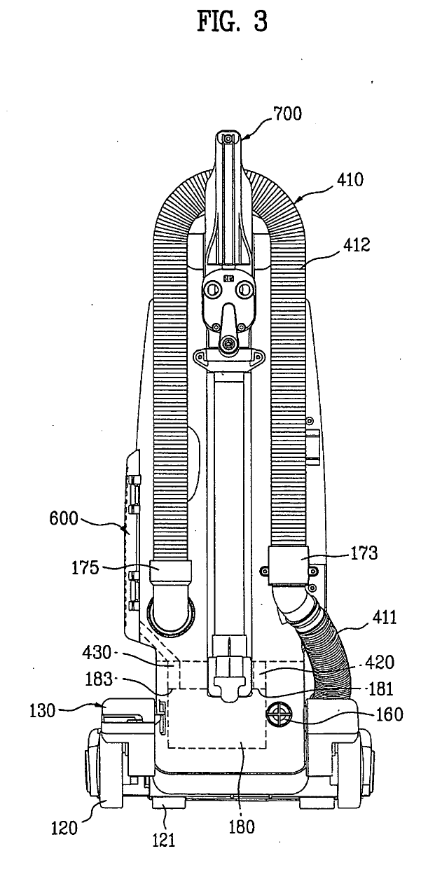

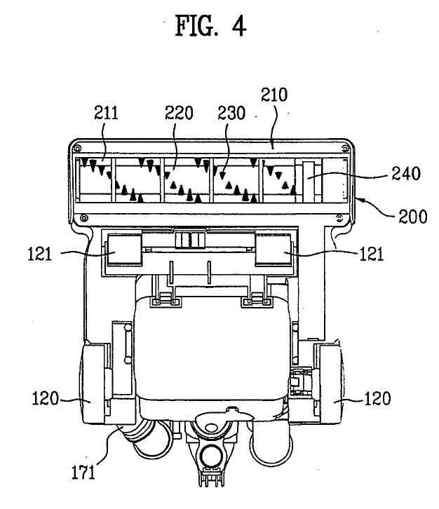

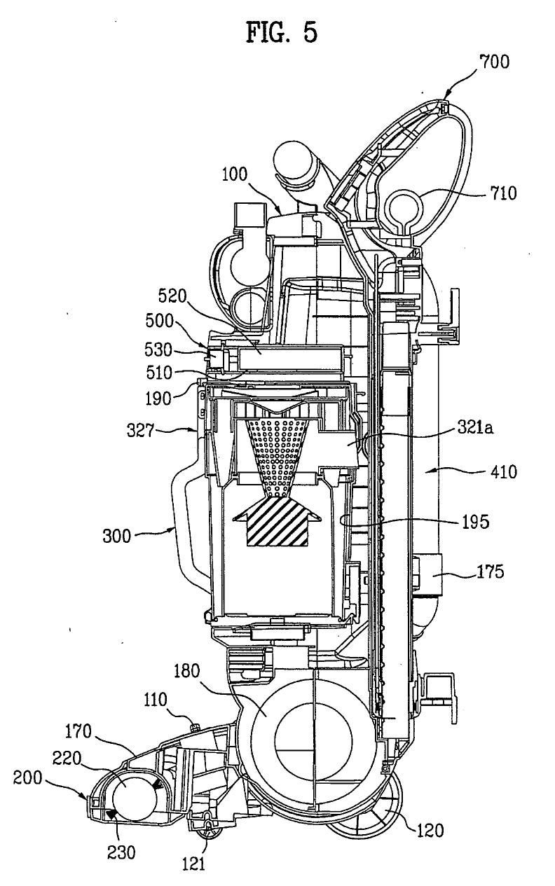

Referring to FIGS. 1-5, an upright vacuum cleaner includes a cleaner body 100, a nozzle section 200 connected to the cleaner body 100, and conduits for guiding the suction airflow from the nozzle section 200 to the atmosphere through the cleaner body 100.

The cleaner body 100 and the nozzle section 200 are connected through a pivot or hinge, such as a suitable hinge assembly, so that the cleaner body 100 pivots between a generally vertical storage position (as shown) and an inclined, operative position.

The nozzle section 200 includes a nozzle case 210, a suction opening 211 which is formed at the underside of the nozzle case 210, and a rotating brush assembly which is provided in the nozzle case 210. Front wheels 121 and rear wheels 120 are rotatably mounted to the underside of the nozzle case 210 to enable the nozzle section 200 to smoothly move on a floor.

The suction opening 211 extends substantially across the width of the nozzle case 210 at the front end thereof. The suction opening 211 is in fluid communication with the cleaner body 100 through a first conduit 410.

The rotating brush assembly includes an agitator 220, an agitator brush 230 which is provided at the outer circumference of the agitator 220, and a belt 240 for transferring the rotational force of a suction source 180 to the agitator 220.

The agitator 220 is positioned in the region of the suction opening 211 for contacting and scrubbing the surface being vacuumed to loosen embedded dirt and dust. When the rotational force of the suction source 180 is transferred to the agitator 220, the agitator rotates and brushes up contaminants from the surface being cleaned. The rotating brush assembly may further include an agitator motor (not shown) for driving the agitator.

A height adjustment knob 110 is rotatably mounted in the nozzle section 200. The user rotates the height adjustment knob 110 with his/her hand to raise or lower a shaft supporting front wheels (not shown) of the vacuum cleaner, and thus adjust the height of the nozzle section 200. In one implementation, the height adjustment knob 110 is capable of adjusting the height of the nozzle section incrementally and in accordance with the state of the surface to be cleaned.

The cleaner body 100 includes a control part (not shown) for controlling the vacuum cleaner, the suction source 180 for generating the required suction airflow for cleaning operations, and a dust collector 300 for separating contaminants entrained in the suction airflow passed through the suction opening 211. The cleaner body may also include a coupling device including a latch 327 and a coupling protrusion 190 for coupling the dust collector to the cleaner body.

The suction source 180 includes an electronic motor and a fan generating a suction force in a suction source inlet 181 and an exhaust force in a suction source outlet 183. The suction source outlet 183 is in fluid communication with a final filter assembly 600 for filtering the exhaust airflow of any contaminants immediately prior to their discharge into the atmosphere. The suction source inlet 181 is in fluid communication with the dust collector 300 of the cleaner body 100. Alternatively, the suction source may be disposed in the nozzle section 200.

The cleaner body 100 further includes a motor protector 160 for preventing a motor of the suction source from overheating. The motor protector 160 includes a bypass valve (not shown) which automatically opens to provide cooling air to the motor when a clog prevents the normal flow of air to the motor. The cleaner body 100 may also include a thermal protector (not shown) for protecting the vacuum cleaner from overheating. If a clog prevents the normal flow of air to the motor of the suction source, the thermal protector automatically turns the motor off to allow the motor to cool in order to prevent possible damage to the vacuum cleaner.

The cleaner body 100 further includes a handle 700 extending upward therefrom by which a user of the vacuum cleaner is able to grasp and maneuver the vacuum cleaner. The handle 700 includes a telescopic release lever 710 for adjusting the height of the handle according to a height of the user.

When the user wants to raise the handle 700, the user pulls the telescopic release lever 710 up with their fingers and to extend the handle 700. The user pulls the telescopic release lever 710 up with their fingers and pulls down on the handle 700 to lower the handle 700.

The cleaner body 100 further includes a cord hook provided at rear side of the cleaner body 100. The cord hook includes an upper cord hook 141 and a lower cord hook 140 corresponding to the upper cord hook. The space between the upper cord hook 141 and the lower cord hook 140 is sufficient to accommodate the number of turns necessary to store the entire length of the cord. A cord holder (not shown) adjacent to the cord hook prevents the cord releasing from its stored position.

The conduits include a first conduit 410 connecting the suction opening 211 to dust collector 300, a second conduit 420 connecting the dust collector 300 to the suction source inlet 181, and a third conduit 430 connecting the suction source outlet 183 to the atmosphere.

The first conduit 410 includes hoses supported and connected by fitting members. One side of a first fitting member 171 is connected to a first hose 411 and the other side of the first fitting member 171 is connected to a passage 170 which is in fluid communication with the suction opening 211.

A second fitting member 173 connects the first hose 411 to a second hose 412 and a third fitting member 175 connects the second hose 412 to the cleaner body. Each of the first and second hoses (411, 412) is connected detachably to the second fitting member 173.

The vacuum cleaner further includes body release pedal 130 for an inclined operative position of the vacuum cleaner. The body release pedal 130 is pivotably mounted on a mounting portion 131 which is provided at the nozzle section. The body release pedal 130 has a locking protrusion (not shown) protruding from a side thereof. The locking protrusion is sequentially locked into one or more locking recess (not shown) provided at lower side of cleaner body.

When the vacuum cleaner is in use, with cleaner body 100 being rotated at a predetermined angle with respect to a surface to be cleaned, a locking protrusion is locked in one of the inclined position recesses.

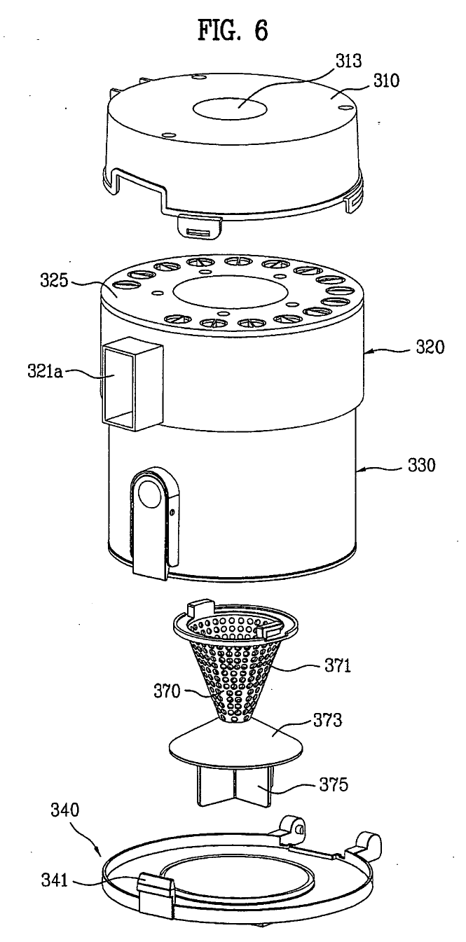

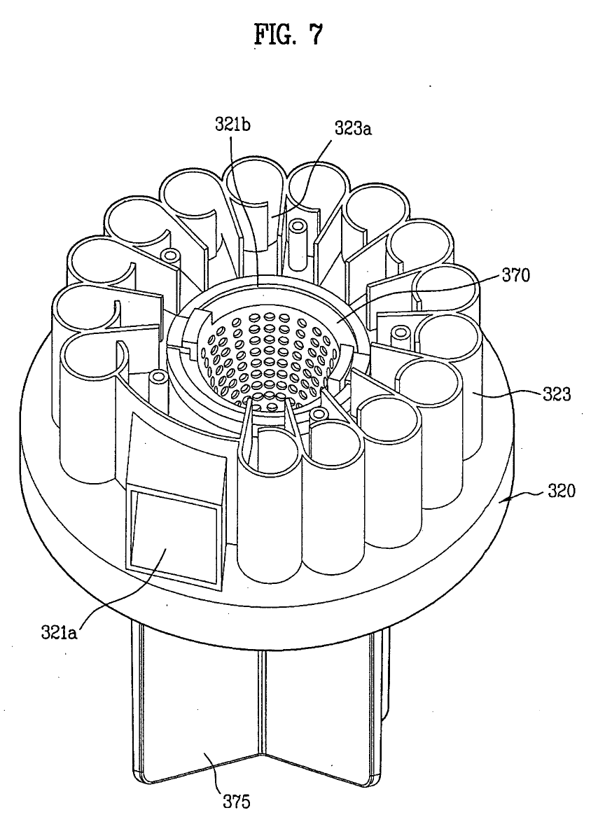

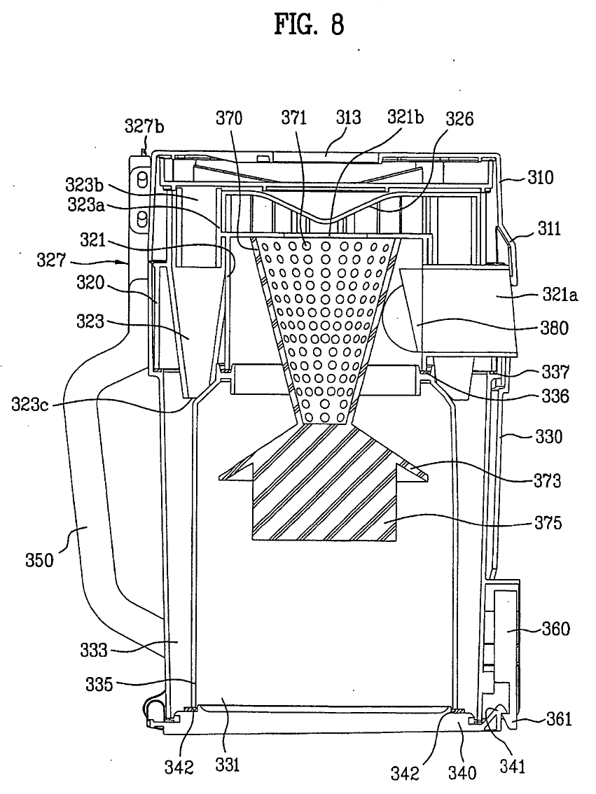

Referring to FIGS. 6-8, the dust collector 300 includes a cyclonic chamber 320, a dust collecting container 330, a bottom panel 340 which is positioned at lower end of the dust collecting container 330 and a top cover 310 which is positioned at an upper end of the dust collecting container 330 and detachably connected to the dust collecting container 330.

The dust collector 300 further includes a dust collector handle 350 which is provided on the exterior of the dust collecting container 330 for handling the container. The latch 327 is positioned at the upper end of the dust collector handle 350 and the coupling protrusion 190 is formed at the front portion of the cleaner body for coupling the dust collector 300 to the cleaner body 100. The latch 327 includes a fastening bar 327a having a hook 327b, and the coupling protrusion 190 includes a mating groove (not shown) corresponding to the hook.

When the user intends to couple the dust collector 300 to the cleaner body 100, the user inserts the dust collector into a socket 195 formed in the cleaner body. Next, the user moves the fastening bar 327a upward. The hook 327b of the fastening bar is then inserted into the mating groove of the coupling protrusion 190. The fastening bar 327a may also be biased through use of a spring or other resilient member, or via the natural resiliency of the plastic from which it is molded.

The cyclonic chamber 320 includes a primary cyclone 321 and at least one secondary cyclone 323. The primary cyclone 321 separates dust and dirt from the suction airflow passed through the suction opening 211. The secondary cyclone 323 separates dust and dirt entrained in the airflow discharged from the primary cyclone 321.

The primary cyclone 321 has a downwardly-opened cylindrical container shape. A primary airflow inlet 321a is formed through an upper portion of the primary cyclone 321 at one side of the primary cyclone 321. A primary airflow outlet 321b is formed through the top of the primary cyclone 321 such that the primary airflow outlet 321b extends vertically.

The primary airflow inlet 321a is tangentially oriented and arranged so that the airflow entering the primary cyclone 321 through the primary airflow inlet 321a moves cyclonically within the primary cyclone 321. That is, the primary airflow inlet 321a guides dirt-laden air into the cyclonic chamber 320 in a tangential direction of the primary cyclone 321 so that the air flows spirally along an inner wall surface of the primary cyclone 321.

The secondary cyclones 323 have peripheral walls formed integrally with a peripheral wall of the cyclonic chamber 320, respectively. The secondary cyclones 323 are partitioned from each other by peripheral walls of the secondary cyclones 323. The cyclonic chamber 320 may be constructed as a single piece with the dust collecting container 330 and at least partially defining the dust collecting container 330.

In particular, the secondary cyclones 323 are circumferentially arranged around the primary cyclone 321. Each secondary cyclone 323 has an upper end upwardly protruded to a level higher than that of the upper end of the primary cyclone 321.

The peripheral wall of each secondary cyclone 323 is vertically cut out at a region where the peripheral wall is upwardly protruded above the upper end of the primary cyclone 321, thereby forming a secondary airflow inlet 323a communicating with the primary airflow outlet 321b.

Each secondary cyclone 323 also has a partial, conical shape. That is, the secondary cyclone 323 has a conical portion formed at a lower portion of the secondary cyclone 323 such that the conical portion has a diameter reduced gradually as the conical portion extends toward the bottom of the dust collecting container 330.

A contaminants discharge port 323c is formed at a lower end of each secondary cyclone 323 to downwardly discharge contaminants such as dust.

The secondary cyclones 323 have an integrated structure such that adjacent cyclones 323 of the secondary cyclones 323 are in contact with each other to prevent air from leaking between adjacent secondary cyclones 323.

The cyclonic chamber 320 may further include a chamber cover 325 mounted to the upper end of the cyclonic chamber 320 to open or close the upper ends of the secondary cyclones 323.

A flow passage guide 326 is provided at the underside of the chamber cover 325. The flow passage guide 326 more smoothly guides air emerging from the primary airflow outlet 321b to the secondary cyclones 323.

The secondary airflow inlet 323a of each secondary cyclone 323 guides air discharged from the primary airflow outlet 321b to flow in a tangential direction of the secondary cyclone 323, so that the air entering the secondary airflow inlet 323a flows spirally along an inner wall surface of the secondary cyclone 323.

Secondary airflow outlets 323b are formed at the chamber cover 325 along the peripheral portion of the chamber cover 325 to discharge air from the secondary cyclones 323, respectively.

Dust separated in the primary cyclone 321 and second cyclones 323 is stored in a dust storing part formed by the dust collecting container 330. The stored dust is subsequently outwardly discharged by virtue of gravity when the bottom panel 340 is opened.

An opening/closing device 360 is mounted to the peripheral wall of the dust collecting container 330 to open or close the bottom panel 340. The opening/closing device 360 includes a locking hook 361 for locking the bottom panel 340. The bottom panel 340 may also include a mating hook 341 corresponding to the locking hook 361.

The dust collecting container 330 may be at least partially transparent so that an operator of the vacuum cleaner is able to view the level of dirt and dust accumulated therein for purposes of determining when the dust collecting container should be emptied.

The dust storing part includes a primary dust storing part 331 for storing the dust separated by the primary cyclone 321, and a secondary dust storing part 333 for storing dust separated by the secondary cyclones 323.

The primary dust storing part 331 and secondary dust storing part 333 are partitioned by a substantially cylindrical boundary wall 335, which is connected to the secondary cyclones 323, and has a diameter smaller than that of the peripheral wall of the dust collecting container 330.

The boundary wall 335 has a lower end extending downward to the bottom of the dust collecting container 330, that is, the upper surface of the bottom panel 340, beyond the lower end of the primary cyclone 321.

The boundary wall 335 may have a circumferentially corrugated shape, in order to prevent the dust stored in the primary dust storing part 331 from floating due to a spiral air flow formed in the primary cyclone 321.

A sealing member 342 is mounted between the boundary wall 335 and the bottom panel 340. The sealing member 342 may be formed of an elastic material and/or be formed having a cylindrical shape. The sealing member 342 prevents the primary dust storing part 331 from communicating with the secondary dust storing parts 333.

In addition to the above-described configuration, the dust collector 300 may include a discharge member 370 mounted on the upper end of the primary cyclone 321. A plurality of holes 371 are formed at a peripheral wall of the discharge member 370, in order to allow the discharge member 370 to communicate with the primary airflow outlet 321b of the primary cyclone 321.

It is preferred that the discharge member 370 be centrally arranged in the primary cyclone 321, extend axially through the primary cyclone 321, and have a substantially conical structure having an opened upper end and a closed lower end while having a diameter gradually reduced as the discharge member 370 extends downward.

When the discharge member 370 has such a structure, the velocity of the spiral air flow in the primary cyclone 321 is gradually reduced toward the lower end of the primary cyclone 321. Therefore, it is possible to prevent dust from being influenced by a suction force exerted in the discharge member 370. Alternatively, the discharge member 370 may be formed having different shapes, such as a cylindrical shape.

The upper end of the discharge member 370 is operatively coupled with the peripheral edge of the primary airflow outlet 321b. An annular sealing member (not shown), which provides a sealing effect, may be interposed between the upper end of the discharge member 370 and the primary airflow outlet 321b.

A floatation prevention member 373 may also be mounted to the lower end of the discharge member 370, in order to prevent the dust collected in the primary dust storing part 331 from rising due to the spiral air flow, and thus, from re-entering the flow of air to the primary cyclone 321.

For such a function, it is preferred that the floatation prevention member 373 have a radially-extending structure formed integrally with the lower end of the discharge member 370. It is also preferred that the floatation prevention member 373 has a downwardly-inclined upper surface. Specifically, the floatation prevention member 373 has a conical structure having a diameter gradually increased as the floatation prevention member 373 extends downward.

A cross blade 375 may also be attached under the floatation prevention member 373 for preventing swirling airflow in the primary dust storing part 331. The cross blade 375 may help to reduce air turbulence in the primary dust storing part 331 that may cause dust to rise up.

The dust collector 300 also includes a guide rib 380 provided at the primary cyclone 321. The guide rib 380 guides air entering the primary airflow inlet 321a to flow in a direction tangential to the inner peripheral wall surface of the primary cyclone 321. That is, the guide rib 380 prevents the air entering the primary airflow inlet 321a from being directly introduced into the discharge member 370.

A main filter assembly 500 is located on the dust collector 300 for filtering contaminants from the airflow discharged from the secondary cyclone 323. Referring to FIGS. 1-5, the main filter assembly 500 includes a filter housing 510 and a main filter element 520 mounted in the filter housing 510 and a filter housing knob 530 for handling the filter housing.

The filter housing 510 coupled detachably to the cleaner body receives and retains the main filter element 520. The filter housing 510 includes a plurality of apertures, slots, or other passages formed therethrough, preferably in the lower half thereof, so that the suction airflow flows freely from the cover discharge port 313 into the filter housing 510 and to the main filter element 520.

It is preferable that the main filter element 520 is made of permeable material. For cleaning the main filter element 520, the user is able to detach the filter housing 510 from the cleaner body by rotating and drawing out the filter housing knob 530.

The main filter element 520 may include Porex. RTM brand high density polyethylene-based open-celled porous media available commercially from Porex Technologies Corp., Fairburn, Ga. 30213, or an equivalent foraminous filter member. The main filter element 520 may be a rigid open-celled foam that is moldable, machinable, and otherwise workable into any shape as deemed advantageous for a particular application.

The main filter assembly 500 may further include a filter support member (not shown) for supporting and securing the main filter element 520. The filter support member is formed at the inner frame of the filter housing.

The cleaner body 100 also may include a final filter assembly 600 for filtering the suction airflow immediately prior to its exhaustion into the atmosphere. The preferred final filter assembly 600 includes a final filter element 610 and a final filter housing 620 for retaining the final filter element.

The final filter element 610 is preferably a high efficiency particulate arrest (HEPA) filter element in a sheet or block form. The final filter housing 620 has protective grid or grate structure for securing the final filter element 610 in place.

The final filter assembly 600 will remove the contaminants, such that only contaminant-free air is discharged into the atmosphere.

An exemplary operation of the vacuum cleaner having the dust collector 300 of FIGS. 1-8, will be described in greater detail hereinafter.

The suction source 180 establishes a suction force at its suction source inlet 181, in the elongated first conduit 410, and thus in the primary cyclone 321.

This suction force or negative pressure in primary cyclone 321 is communicated to the suction opening 211 formed in the nozzle underside through the hoses and associated fitting members. In combination with the scrubbing action of the rotating brush assembly, the suction force causes dust and dirt from the surface being cleaned to be entrained in the suction airflow and pulled into the primary cyclone 321 through the primary airflow inlet 321a.

The air introduced into the primary cyclone 321 is guided by the guide rib 380 to flow in a direction tangential to the inner peripheral surface of the primary cyclone 321 without being directly introduced into the discharge member 370, thereby imparting a spiral flow to the airflow entering the primary cyclone 321.

The air acquires a certain swirling force, and the swirling force separates heavy and large dust particles. As a result, relatively heavy and large dust is separated from the air in accordance with the cyclone principle, and is then stored in the primary dust storing part 331 after falling downward.

The dust stored in the primary dust storing part 331 is prevented from floating in accordance with the functions of the floatation prevention member 373 and corrugated boundary wall 335.

The air, from which relatively heavy and large dust has been separated, is discharged from the primary cyclone 321 through the primary airflow outlet 321b communicating with the holes 371 formed at the peripheral wall of the discharge member 370.

The finer dust is then filtered through the discharge member 370 placed between the primary cyclone 321 and the secondary cyclones 323. Also, the air is then introduced into the secondary cyclones 323 so that the air is again subjected to a dust separation process, in order to separate relatively light and fine dust from the air.

The air, from which relatively light and fine dust has been separated in the secondary cyclones 323, is introduced into the interior of the top cover 310 through the secondary airflow outlets 323b. The air introduced into the interior of the top cover 310 is discharged through a cover discharge port 313 formed at the center of the top cover 310. The air emerging from the cover discharge port 313 is introduced into the main filter assembly 500.

The air passes through the apertures formed in the filter housing 510, passes through the main filter element 520 so that residual contaminants are removed, and exits the main filter assembly 500. The air discharging from the main filter assembly 500 is introduced into the suction source 180 through the second conduit 420. The air emerging from the suction source outlet 183 is then introduced into the final filter assembly 600 through the third conduit 430.

In the final filter assembly 600, the air is filtered again by the HEPA filter to remove any contaminants that passed through the dust collector 300 and the main filter assembly 500. The air passed through the final filter assembly 600 is outwardly discharged from the vacuum cleaner to atmosphere.

Implementations of the above-described vacuum cleaner may provide one or more of the following advantages. For example, the simple coupling structure may be relatively convenient to use since the dust collector can be coupled to the cleaner body by virtue of operation of the latch corresponding to the coupling protrusion. The motor of the suction source may be prevented from overheating due to clogging by automatically controlling a bypass valve for providing cooling air to the motor. The vacuum cleaner may also separate dust and dirt from the airflow and deposit the dust and dirt into the dust collecting container easily and conveniently.

Other implementations are within the scope of the following claims.

What is claimed is:

1. A vacuum cleaner comprising:
a cleaner body;
a dust collector coupled to the cleaner body, the dust collector comprising a cyclonic chamber and a dust collecting container,
the cyclonic chamber includes a primary cyclone being in fluid communication with the cleaner body and having a primary airflow inlet located on an upper portion of the primary cyclone at one side of the primary cyclone and a primary airflow outlet located on an upper portion of the primary cyclone at the center of the primary cyclone, and at least one secondary cyclone disposed around the primary cyclone for separating contaminants entrained in the airflow discharged from the primary cyclone, and
the dust collecting container includes a primary dust storing part for storing contaminants separated in the primary cyclone, and a secondary dust storing part for storing contaminants separated in the at least secondary cyclone;
a suction source located in the cleaner body, and having a suction source inlet in fluid communication with the dust collector and a suction source outlet; and
a main filter assembly in fluid communication with the dust collector for filtering contaminants from the airflow discharged from the at least one secondary cyclone.

2. The vacuum cleaner of claim 1, further comprising a coupling device for coupling the dust collector to the cleaner body.

3. The vacuum cleaner of claim 2, wherein the coupling device includes a coupling protrusion formed at a front portion of the cleaner body and a latch provided at an upper end of the dust collector.

4. The vacuum cleaner of claim 3, wherein the latch includes a fastening bar operable between a first upward position for coupling the dust collector to the cleaner body and a second downward position for detaching the dust collector from the cleaner body.

5. The vacuum cleaner of claim 4, wherein the fastening bar includes a hook corresponding to a mating groove formed at the coupling protrusion.

6. The vacuum cleaner of claim 1, wherein the primary cyclone has a cylindrical shape.

7. The vacuum cleaner of claim 6, wherein the primary airflow inlet of the primary cyclone is tangentially oriented in relation to an axial centerline of the primary cyclone.

8. The vacuum cleaner of claim 1, wherein the at least one secondary cyclone has a partial conical shape.

9. The vacuum cleaner of claim 8, wherein each of the secondary cyclones is partitioned from an adjacent secondary cyclone.

10. The vacuum cleaner of claim 1, wherein the main filter assembly includes a main filter element that comprises an expanded polytetrafluoroethylene (PTFE) membrane.

11. The vacuum cleaner of claim 1, further comprising a final filter assembly connected in fluid communication with the suction source outlet and adapted for filtering the airflow exhausted by the suction source prior to the airflow being dispersed into the atmosphere, wherein the final filter assembly comprises a high efficiency particulate arrest (HEPA) filter medium.

12. The vacuum cleaner of claim 1, wherein contaminants from a surface being cleaned are entrained in an airflow pathway, the airflow pathway extending:
(a) from the cleaner body into the primary cyclone through the primary airflow inlet;
(b) downwardly from the primary airflow inlet and in a spiral within the primary cyclone so that the entrained contaminants are separated from the suction airflow;
(c) upwardly from the primary cyclone into the at least one secondary cyclone through a secondary airflow inlet of the at least one secondary cyclone;
(d) downwardly from the secondary airflow inlet and in a spiral within the at least one secondary cyclone so that contaminants are separated from the airflow flowing into the at least one secondary cyclone; and
(e) upwardly from the at least one secondary cyclone into the suction source passing through the main filter assembly.

13. A vacuum cleaner comprising:
a nozzle section defining a suction opening;
a cleaner body pivotally mounted to the nozzle section and in fluid communication with the nozzle section;
a primary cyclone for separating contaminants from an airflow, the primary cyclone being in fluid communication with the suction opening;
at least one secondary cyclone for separating contaminants entrained in the airflow discharged from the primary cyclone;
a suction source having a suction source inlet in fluid communication with the at least one secondary cyclone and a suction source outlet in fluid communication with the atmosphere; and
a thermal protection device for preventing a motor of the suction source from overheating.

14. The vacuum cleaner of claim 13, further comprising a conduit operatively connecting the suction opening in fluid communication with a primary airflow inlet of the primary cyclone.

15. The vacuum cleaner of claim 14, further comprising a fitting member for supporting and connecting the conduit to a passage which is in fluid communication with the suction opening.

16. The vacuum cleaner of claim 13, further comprising a main filter assembly including a main filter element, wherein the main filter element is located adjacent an upper portion of the at least one secondary cyclone.

17. The vacuum cleaner of claim 16, wherein the main filter element is supported by a filter support member.

18. The vacuum cleaner of claim 14, wherein the primary airflow inlet is tangentially oriented and arranged so that the airflow entering the primary cyclone through the primary airflow inlet moves spirally within the primary cyclone.

19. An upright vacuum cleaner comprising:
a nozzle section defining a suction opening;
a cleaner body coupled with the nozzle section about a hinge;
a primary cyclone for separating contaminants from an airflow, the primary cyclone being in fluid communication with the suction opening;
at least one secondary cyclone for separating contaminants entrained in the airflow discharged from the primary cyclone;
a suction source having a suction source inlet in fluid communication with the at least one secondary cyclone and a suction source outlet in fluid communication with the atmosphere; and
a main filter assembly including a main filter element, the main filter element being located on an upper portion of the at least one secondary cyclone.

20. The upright vacuum cleaner of claim 19, wherein the at least one secondary cyclone is disposed in a position around a periphery of the primary cyclone.

21. The upright vacuum cleaner of claim 20, wherein each of the secondary cyclones is partitioned from an adjacent secondary cyclone.

22. The upright vacuum cleaner of claim 19, wherein a primary airflow inlet of the primary cyclone is tangentially oriented and arranged so that the airflow entering the primary cyclone through the primary airflow inlet moves spirally within the primary cyclone.

23. The upright vacuum cleaner of claim 19, further comprising a conduit operatively connecting the suction opening in fluid communication with a primary airflow inlet of the primary cyclone.

24. A method of cleaning a surface with an upright vacuum cleaner comprising a suction source, a cleaner body, a dust collector coupled to the cleaner body, a dust collecting container and a filter assembly, the dust collector including a cyclonic chamber having a primary cyclone in fluid communication with the cleaner body and at least one secondary cyclone disposed around a periphery of the primary cyclone, the method comprising:
activating the suction source to produce an airflow pathway for entraining contaminants from the surface into the airflow pathway, and
exhausting air from the upright vacuum cleaner, wherein the airflow pathway extends (a) from the cleaner body of the vacuum cleaner into the primary cyclone; (b) in a spiral within the primary cyclone so that the entrained contaminants are separated from the suction airflow; (c) upwardly from the primary cyclone into the at least one secondary cyclone; (d) in a spiral within the at least one secondary cyclone so that contaminants are separated from the airflow flowing into the secondary cyclone; and (e) upwardly from the secondary cyclone and passing through the main filter assembly.
